(19) United States
(12) Patent Application Publication
(10) Pub. No.: US 2012/0282503 A1
(43) Pub. Date: Nov. 8, 2012

(54) ELECTRIC DEVICE

(75) Inventors: Masato Fujikawa, Osaka (JP); Masatoshi Nagayama, Osaka (JP); Takuya Nakashima, Osaka (JP); Shunsuke Yasui, Osaka (JP); Keisuke Shimizu, Osaka (JP)

(73) Assignee: PANASONIC CORPORATION, Osaka (JP)

(21) Appl. No.: 13/388,825

(22) PCT Filed: Jun. 16, 2011
(86) PCT No.: PCT/JP2011/003446

§ 371 Date: Feb. 3, 2012

(30) Foreign Application Priority Data
Sep. 9, 2010 (JP) 2010-202266

(51) Int. Cl. H01M 2/12

(52) U.S. Cl. 429/82

(57) ABSTRACT

An electric device 100 which has a battery pack 30 including a plurality of batteries 20 is disclosed. The electric device 100 has a holding unit 40 which accommodates at least the battery pack 30, and is capable of being carried by a user. Each of the plurality of batteries 20 included in the battery pack 30 has a release portion 8a for releasing gas generated in the battery 20 in the event of abnormal heat generation in the battery 20. The battery pack 30 is accommodated in the holding unit 40 such that the gas is released from the release portion 8a of the battery 20 in a direction away from the user when the holding unit 40 is carried by the user.

### TECHNICAL FIELD

The present disclosure relates to electric devices having, as a power supply, a battery pack which includes a plurality of batteries.

### BACKGROUND ART

Battery packs which include a plurality of batteries are widely used as power supplies for actuating electric devices. For example, in the case of electric devices (electric power tools) such as a grass cutter and a sprayer, a battery pack, a motor, etc. of the electric devices may be accommodated in a holding unit, and if the user carries the holding unit on his/her back, the user can work (e.g., cut grass) while walking, and workability is improved.

If an internal short-circuit or the like has occurred in a battery such as a lithium ion battery, abnormal heat generation occurs in the battery, and high-temperature and high-pressure gas is generated. To prevent this, each battery is provided with a release portion (a safety valve) for releasing the generated gas to the outside of the battery. It is necessary to release the gas released from the abnormal heat generating battery, also from the battery pack including a plurality of such batteries.

For example, Patent Document 1 discloses a structure in which gas released from an abnormal heat generating battery is released from a battery pack through a path connected to a release portion. Patent Document 1 further discloses a structure in which the gas released from the abnormal heat generating battery is released from the battery carrying device which has the battery pack, through an external path connected to a path in the battery pack. Since the exhaust opening of the external path is located on a surface different from a surface which faces the user of the battery carrying device, the gas released from the exhaust opening to the outside is not directed to the user. Therefore, safety of the user can be ensured.

### CITATION LIST

### Patent Document

Patent Document 1: Japanese Patent Publication No. 2008-117765

### SUMMARY OF THE INVENTION

### Technical Problem

Indeed, the user can be protected from the damage caused by the high-temperature gas by positioning the exhaust opening of the external path at a location shown in Patent Document 1. However, the external path itself in the battery carrying device is also exposed to, and is heated by the high-temperature gas. Therefore, if the heat is transferred to the casing of the battery carrying device, the user may be damaged by the high-temperature gas by touching the battery carrying device. Particularly in the case where a battery pack holding unit is carried on the user's back (e.g., a backpack-type grass cutter), there is an increased possibility that the user may be damaged by the high-temperature gas.

The present disclosure was made in view of the above problems, and it is an objective of the invention to provide a safe electric device whose battery pack holding unit is carried by the user, and which does not cause any thermal damage to the user even in the event of abnormal heat generation in the batteries included in the battery pack.

### Solution to the Problem

To solve the above problems, according to an electric device of the present disclosure, a battery pack is accommodated in a holding unit such that gas is released from a release portion of a battery in a direction away from a user when the holding unit in which the battery pack is accommodated is carried by the user.

Specifically, an electric device according to the present invention is an electric device which has a battery pack including a plurality of batteries, wherein the electric device has a holding unit which accommodates at least the battery pack, and is capable of being carried by a user, each of the plurality of batteries included in the battery pack has a release portion for releasing gas generated in the battery in the event of abnormal heat generation in the battery, and the battery pack is accommodated in the holding unit such that the gas is released from the release portion of the battery in a direction away from the user when the holding unit is carried by the user.

### Advantages of the Invention

According to the present disclosure, a battery pack is accommodated in a holding unit such that gas is released from a release portion of a battery in a direction away from the user when the holding unit is carried by the user. This means that a portion of the casing of the battery pack which is exposed to, and is heated by the high-temperature gas is apart from the user. Accordingly, even if the heat of the portion of the battery pack casing is transferred to a portion of the casing of the holding unit, the portion of the casing of the holding unit is apart from the user. Therefore, it is possible to prevent the holding unit from being heated to a high temperature on the side in contact with the user. Accordingly, it is possible to provide a safe electric device which does not cause any thermal damage to the user in the event of abnormal heat generation in the batteries included in the battery pack.

### BRIEF DESCRIPTION OF THE DRAWINGS

FIG. 1 is an oblique view which schematically shows a structure of an electric device according to one embodiment of the present disclosure.

FIG. 2 is a cross-sectional view which schematically shows a structure of a holding unit according to one embodiment of the present disclosure.

FIG. 3 is a cross-sectional view of an example battery used in a battery pack.

FIG. 4 is a cross-sectional view which shows a structure of a holding unit in which a battery pack according to another embodiment of the present disclosure is accommodated.

FIG. 5(a) is a cross-sectional view of a battery pack according to another embodiment of the present disclosure. FIG. 5(b) is an enlarged view of part of FIG. 5(a).

FIG. 6 is a cross-sectional view which shows a structure of a holding unit in which a battery pack according to another embodiment of the present disclosure is accommodated.

### DESCRIPTION OF EMBODIMENTS

Embodiments of the present disclosure will be described in detail below with reference to the drawings. The present disclosure is not limited to the following embodiments. Further, the embodiment can be modified without deviating from the effective scope of the present disclosure, and can be combined with other embodiments.

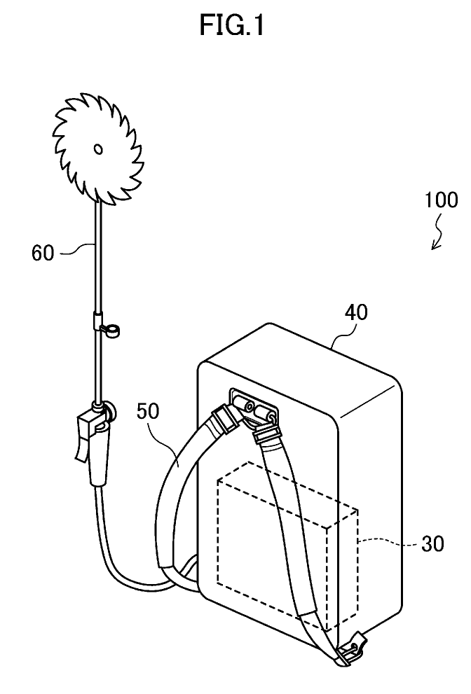

FIG. 1 is an oblique view which schematically shows a structure of an electric device 100 according to one embodiment of the present disclosure. In the present embodiment, a backpack-type grass cutter will be described as an example electric device which has a battery pack including a plurality of batteries.

As shown in FIG. 1, the electric device 100 has a holding unit 40 which accommodates at least a battery pack 30, and which is capable of being carried by the user. The holding unit 40 accommodates, for example, a motor (not shown) for driving a saw blade of the grass cutter in addition to the battery pack 30. Further, a pole 60 having the saw blade at one end is connected to the holding unit 40. The user of the electric device 100 can carry the holding unit 40 on his/her back during grass cutting, with the shoulder bands 50 attached to the holding unit 40 on their shoulders.

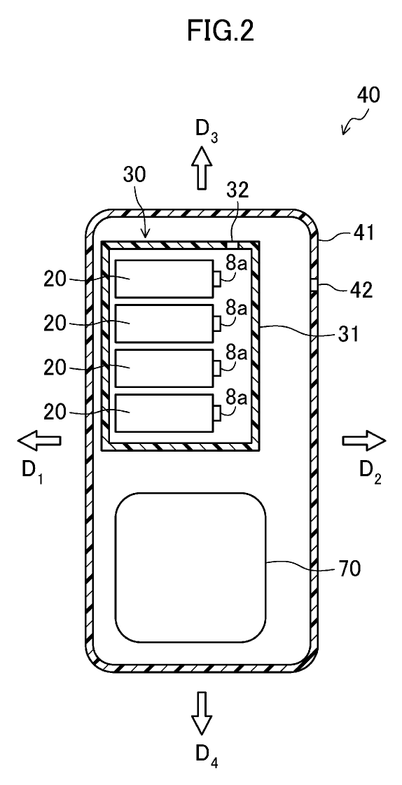

FIG. 2 is a cross-sectional view which schematically shows a structure of the holding unit 40 according to the present embodiment. As shown in FIG. 2, the holding unit 40 accommodates a battery pack 30 including a plurality of batteries 20, and a motor 70. The motor 70 is connected to the battery pack 30 by wiring (not shown), and is actuated by an voltage output from the battery pack 30. Further, each of the batteries 20 has a release portion 8a for releasing gas generated in the battery 20 in the event of abnormal heat generation in the battery 20.

Here, the arrow D₁ shown in FIG. 2 is the direction toward the user when the holding unit 40 is carried by the user. The battery pack 30 is accommodated in the holding unit 40 such that the gas is released from the release portion 8a of a battery 20 in a direction away from the user when the holding unit 40 is carried by the user. For example, in the case where the release portion 8a of a battery 20 is formed at the protrusion of the positive electrode as shown in FIG. 2, the direction of the gas released from the release portion 8a of the battery 20 is opposite (D₂) to the direction toward the user.

As described above, the battery pack 30 is accommodated in the holding unit 40 such that the gas is released from the release portion 8a of a battery 20 in the direction away from the user. Thus, even if a portion of the casing of the battery pack 30 which faces the release portion 8a is exposed to, and is heated by the high-temperature gas released from the release portion 8a, the portion of the casing of the battery pack 30 is located apart from the user. Accordingly, even if the heat of the portion of the casing of the battery pack 30 is transferred to the casing 41 of the holding unit 40, this portion of the casing of the holding unit 40 is also apart from the user. Therefore, it is possible to prevent the casing 41 of the holding unit 40 from being heated to a high temperature on the side in contact with the user. Thus, it is possible to provide a safe electric device 100 which does not cause any thermal damage to the user in the event of abnormal heat generation in the batteries 20 included in the battery pack 30.

The high-temperature gas released from the release portion 8a of the battery 20 is released into the holding unit 40 through an opening 32 formed in the casing 31 of the battery pack 30, and released to the outside of the holding unit 40 through the opening 42 formed in the casing 41 of the holding unit 40. Thus, to prevent the user from being exposed to the high-temperature gas released through the opening 42 of the holding unit 40, it is preferable to form the opening 42 in the casing 41 opposite to the user.

Here, the direction of the gas released from the release portion 8a of the battery 20 is not limited to the direction D₂ opposite to the direction toward the user, but may be at least different from the direction D₁ facing the user. For example, the direction of the gas released from the release portion 8a of the battery 20 may be directions D₃, D₄ orthogonal to the direction D₁ facing the user.

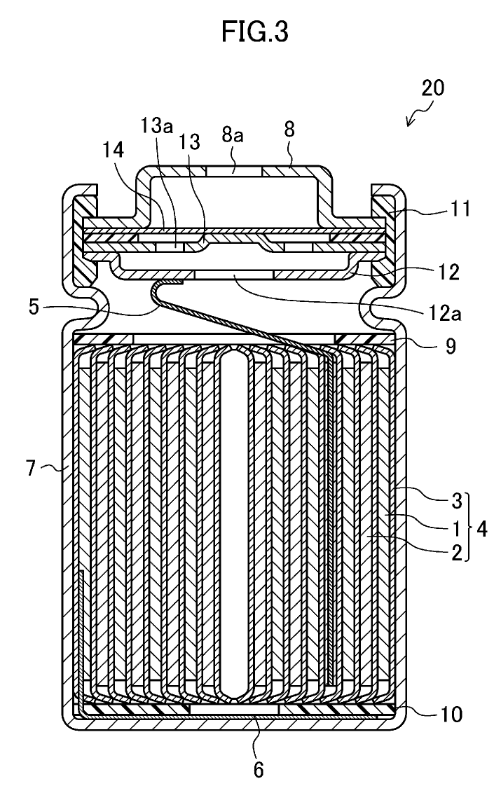

FIG. 3 is a cross-sectional view of an example battery 20 used in the battery pack 30. In the present embodiment, the structure of the battery 20 is not limited to this structure.

As shown in FIG. 3, an electrode group 4 in which a positive electrode 1 and a negative electrode 2 are wound with a separator 3 interposed therebetween is housed in a battery case 7 with a nonaqueous electrolyte. Insulating plates 9, 10 are placed on the upper and lower ends of the electrode group 4. The positive electrode 1 is connected to a filter 12 via a positive electrode lead 5, and the negative electrode 2 is connected to the bottom of the battery case 7 which also functions as a negative electrode terminal, via a negative electrode lead 6.

The filter 12 is connected to an inner cap 13, and a protrusion of the inner cap 13 is connected to a metallic exhaust valve 14. The exhaust valve 14 is connected to a terminal plate 8 which also functions as a positive electrode terminal. The terminal plate 8, the exhaust valve 14, the inner cap 13, and the filter 12 are integrated to seal an opening of the battery case 7 with a gasket 11 interposed therebetween.

If an internal short-circuit or the like occurs in a battery 20, and the pressure in the battery 20 increases, the exhaust valve 14 swells to the terminal plate 8. A current path is cut when the inner cap 13 and the exhaust valve 14 are disconnected from each other. Further, the exhaust valve 14 breaks when the pressure in the battery 20 increases. Consequently, the gas generated in the battery 20 is released to the outside through a through hole 12a of the filter 12, a through hole 13a of the inner cap 13, a crack in the exhaust valve 14, and the release portion 8a formed in the center of the protruded part of the terminal plate 8.

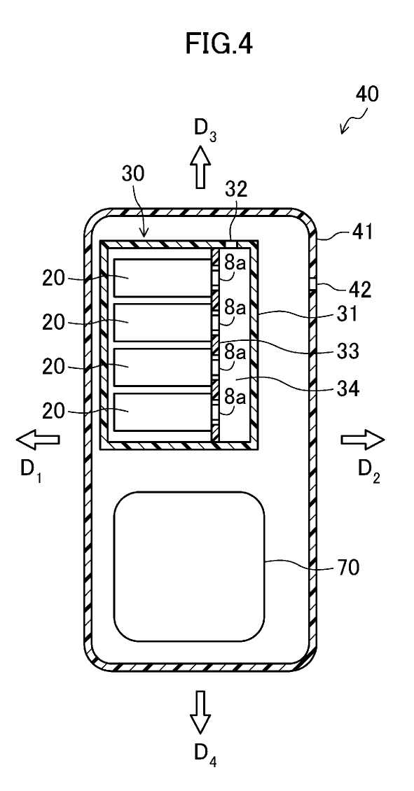

FIG. 4 is a cross-sectional view which shows a structure of a holding unit 40 in which a battery pack 30 according to another embodiment of the present disclosure is accommodated. In the battery pack 30 shown in FIG. 2, the high-temperature gas released from the release portion 8a of the battery 20 is released to the outside of the battery pack 30 through the opening 32 formed in the casing 31 of the battery pack 30. The structure in the present embodiment is different from this structure shown in FIG. 2 in that the battery pack 30 further includes an exhaust path 34 for releasing the gas released from the release portions 8a of the plurality of batteries 20 to the outside of the battery pack 30.

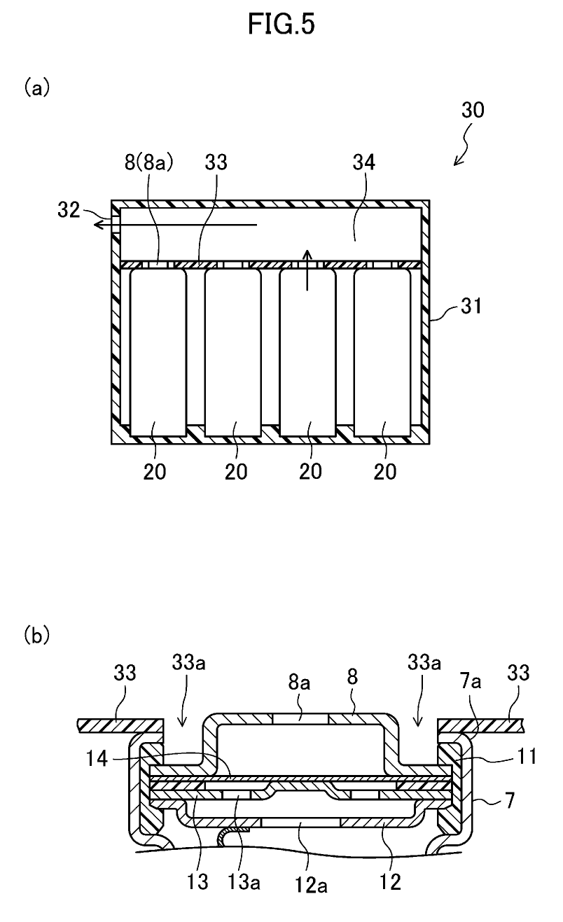

If abnormal heat generation occurs in a battery 20, and the normal batteries 20 in the battery pack 30 are exposed to the high-temperature gas released from the release portion 8a of the abnormal heat generating battery 20, abnormal heat generation may sequentially occur in the batteries around the abnormal heat generating battery 20. Thus, to prevent the other batteries from being exposed to the high-temperature gas released from the release portion 8a of the abnormal heat generating battery 20, the exhaust path 34 for releasing the gas released from the release portions 8a of the plurality of batteries 20 to the outside of the battery pack 30 may be provided in the battery pack 30 as shown in FIGS. 5(a) and 5(b). FIG. 5(a) is a cross-sectional view of the battery pack 30. FIG. 5(b) is an enlarged view of part of FIG. 5(a).

As shown in FIGS. 5(a) and 5(b), a flat plate 33 is placed so as to be in contact with one end of each battery 20, and the release portion 8a of each battery 20 is inserted in the corresponding one of the plurality of through holes 33a formed in the flat plate 33. Consequently, the exhaust path 34 surrounded by the flat plate 33 and the casing 31 of the battery pack 30 is formed. The exhaust path 34 is hermetically sealed on the side where the batteries 20 are accommodated. Thus, the high-temperature gas released from the release portions 8a of the batteries 20 to the exhaust path 34 will not return to the side where the batteries 20 are accommodated. Accordingly, even if abnormal heat generation occurs in a battery 20, it is possible to prevent abnormal heat from being generated sequentially in the peripheral batteries. The high-temperature gas released into the exhaust path 34 is released to the outside of the battery pack 30 through the opening 32 formed in the casing 31 of the battery pack 30.

However, the exhaust path 34 is heated to a high temperature because the exhaust path 34 is exposed to the high-temperature gas released from the release portions 8a of the batteries 20. Accordingly, as shown in FIG. 4, it is preferable to locate the battery pack 30 in the holding unit 40 such that the exhaust path 34 is located in a direction away from the user when the holding unit 40 is carried by the user. In this structure, since the exhaust path 34 is apart from the user, it is possible to prevent the casing 41 from being heated to a high temperature on the side in contact with the user even when the exhaust path 34 is heated to a high temperature.

Here, the location of the exhaust path 34 is not limited to the place away from the user in the direction D₂, but may be located in the directions at least different from the direction D₁ facing the user. For example, the exhaust path 34 may be located in the directions D₃, D₄ orthogonal to the direction D₁ facing the user.

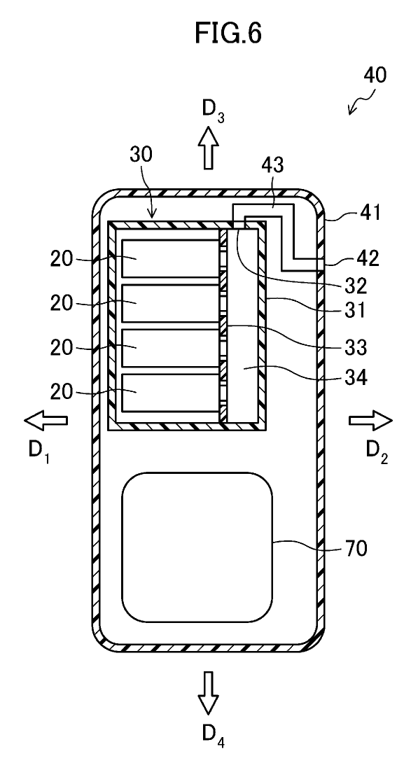

FIG. 6 is a cross-sectional view which shows a structure of a holding unit 40 in which a battery pack 30 according to another embodiment of the present disclosure is accommodated. In the battery pack 30 shown in FIG. 4, the high-temperature gas released from the release portion 8a of an abnormal heat generating battery 20 is released to the outside of the battery pack 30 through the exhaust path 34 provided in the battery pack 30. The structure in the present embodiment is different from this structure shown in FIG. 4 in that the holding unit 40 includes an exhaust duct 43 which communicates with the exhaust path 34 of the battery pack 30.

If the motor 70 and other components (e.g., a circuit board on which a circuit for controlling the motor 70 is mounted) accommodated in the holding unit 40 are exposed to the high-temperature gas released from the battery pack 30, the motor 70 etc. may be thermally damaged. To prevent the motor 70 etc. accommodated in the holding unit 40 from being exposed to the high-temperature gas released from the battery pack 30, the exhaust duct 43 which communicates with the exhaust path 34 of the battery pack 30 may be provided in the holding unit 40 as shown in FIG. 6.

However, the exhaust duct 43 is heated to a high temperature because the exhaust duct 43 is exposed to the high-temperature gas released from the release portion 8a of the battery 20. Accordingly, as shown in FIG. 6, it is preferable that the exhaust duct 43 is located in the holding unit 40 in a direction away from the user when the holding unit 40 is carried by the user. In this structure, since the exhaust duct 43 is apart from the user, it is possible to prevent the casing 41 from being heated to a high temperature on the side in contact with the user even when the exhaust duct 43 is heated to a high temperature.

Here, the location of the exhaust duct 43 is not limited to the place away from the user in the direction of D₂, but may be located in the directions at least different from the direction D₁ facing the user. For example, the exhaust duct 43 may be located in the directions D₃, D₄ orthogonal to the direction D₁ facing the user.

The present disclosure has been described in terms of preferable embodiments. However, the above description does not limit the present disclosure, and of course, various modification can be made. For example, in the above embodiments, a backpack-type grass cutter was described as an example electric device, but the present disclosure is not limited to the backpack-type grass cutter, and is applicable to backpack-type sprayers, electric branch cutter, etc. Examples in which the holding unit is carried on the user's back have been described, but the present discloser is not limited to this type, and the holding unit may be carried, for example, on the user's waist or arm.

### INDUSTRIAL APPLICABILITY

An electric device according to the present disclosure is preferably used, for example, as a backpack-type electric power tool, etc.

### DESCRIPTION OF REFERENCE CHARACTERS

1 positive electrode

2 negative electrode

3 separator

4 electrode group

5 positive electrode lead

6 negative electrode lead

7 battery case

8 terminal plate

8a release portion

9, 10 insulating plate

11 gasket

12 filter

12a through hole

13 inner cap

13a through hole

14 exhaust valve

20 battery

30 battery pack

31 casing

32 opening

33 flat plate

33a through hole

34 exhaust path

40 holding unit

41 casing

42 opening

43 exhaust duct

50 shoulder band

60 pole

70 motor

100 electric device

1. An electric device which has a battery pack including a plurality of batteries, wherein
the electric device has a holding unit which accommodates at least the battery pack, and is capable of being carried by a user,
each of the plurality of batteries included in the battery pack has a release portion for releasing gas generated in the battery in the event of abnormal heat generation in the battery, and
the battery pack is accommodated in the holding unit such that the gas is released from the release portion of the battery in a direction away from the user when the holding unit is carried by the user.

2. The electric device of claim 1, wherein
the battery pack is accommodated in the holding unit such that the gas is released from the release portion of the battery in a direction opposite to the user when the holding unit is carried by the user.

3. The electric device of claim 1, wherein
the battery pack further includes an exhaust path for releasing the gas released from the release portions of the plurality of batteries to the outside of the battery pack, and
the battery pack is accommodated in the holding unit such that the exhaust path is located in the direction away from the user when the holding unit is carried by the user.

4. The electric device of claim 3, wherein
the holding unit has an exhaust duct which communicates with the exhaust path of the battery pack,
the gas generated in the batteries is released to the outside of the holding unit from an exhaust opening formed in the holding unit through the exhaust path and the exhaust duct, and
the exhaust duct is located in the holding unit in the direction away from the user when the holding unit is carried by the user.

5. The electric device of claim 4, wherein
the exhaust opening is formed in the holding unit such that the gas is released from the exhaust opening in the direction away from the user when the holding unit is carried by the user.

6. The electric device of claim 1, wherein the holding unit is carried on the user's back, waist, or arm.
